(19) United States
(12) Patent Application Publication
(10) Pub. No.: US 2004/0118027 A1
(43) Pub. Date: Jun. 24, 2004

(54) Mounted display assembly

(76) Inventor: Ted Alan Tobey, Carmel, CA (US)

Correspondence Address: PATRICK REILLY, BOX 7218, SANTA CRUZ, CA, 95061-7218, US

(21) Appl. No.: 10/329,045

(22) Filed: Dec. 23, 2002

(51) Int. Cl. G09F 3/18

(52) U.S. Cl. 40/654.01

(57) ABSTRACT

A mounted display assembly for easy reader access to printed information is provided. The assembly may include a ring assembly mounted on a spine, where the spine is attached to a wall, vehicle, equipment or instrument. A plurality of transparent display pockets are attached to the ring assembly, or alternately coupled to the spine by a comb binder, a spiral binder, staples, pressure grips, a booklet binding, or other suitable coupling devices known in the art. The display pockets may have slits or openings that permit the insertion and removal of sheets or pages into and from the display pockets.

### FIELD OF INVENTION

This invention relates generally to a mounted display and, more particularly, to a versatile binder having pockets for displaying papers and flat sheets.

### BACKGROUND OF INVENTION

Single sheet paper documents and other sheet-like media are often placed in a binder and provided to a work team or as updates or instructions. These loose-leaf documents are easily removed from certain prior art binders, and the binders may be relocated and misplaced. Three ring binders are often used. These binders may have a spine hingedly connected to a front and back cover. A ring mechanism may be secured to the spine, and the papers may have holes sized and spaced to simultaneously each accept individual rings of the ring mechanism.

Yet users may desire to co-locate a binder with a specific piece of equipment, such as a medical X-ray system or a truck, or to permanently or semi-permanently maintain an informational binder at a specific location, for example near a telephone or a computer, at a work site or an office. The prior art fails to adequately address a long felt need to provide a low-cost, mounted page display system that contains information relevant to a specific location, and wherein the information may in an updated by replacing the sheets. The prior art also fails to substantially meet an addition long felt need to provide a mounted page display system which is aesthetically pleasing, durable, and cost efficiently producible.

### SUMMARY OF INVENTION

To meet with these and other objects that will be made obvious in light of the prior art and this disclosure, a page display system is that may be mounted onto an external object. A first preferred embodiment may be mounted onto an external object, such as a wall or other suitable structure by means of an attachment feature, such as hook and loop fasteners, adhesives, and/or elongate fasteners, e.g., screws or nails. The first preferred embodiment has a spine with optional binder apertures, and at least two display pockets. The optional binder apertures are sized to enable a fastener to extend through the binder. The pockets may be sized and shaped to accept and protect pages of predetermined size, such as an A10 paper or three-inch by five-inch pages, or eight and one half inch by eleven-inch pages. The pages may be paper or sheets of other suitable material known in the art. The pockets are rotatably coupled to the spine, and in cases of multiple pockets may optionally include reference tabs, whereby a reader may position the pockets to allow for more convenient examination or reading of the pages.

In certain alternate preferred embodiments, the mounted display system, or binder assembly, may optionally include the spine, the pockets and a ring mechanism. The ring mechanism is mounted to the spine and presents at least two articulated rings to which the pockets are removabley coupled. The spine may optionally include, in various alternate preferred embodiments of the present invention, hook fastener elements, known in the art as touch-and-close fastener elements, or hook-and-loop fastener elements or ‘Velcro’ fastener elements. A preferred embodiment of the present invention having hook fastener elements may be used within a location wherein more than one matching strip of hook fasteners may be positioned to provide two or more alternate sitings for the mounted page display system having hook fasteners. Certain alternate preferred embodiments of the present invention comprise an adhesive on the spine, the adhesive positioned on the spine to allow the attachment of the display system to the external object while allowing the display pockets to be at least partially rotated by a reader.

In accordance with a second preferred embodiment of the present invention, the binder assembly may include some or all of the following features: 1) a spine; 2) one or more transparent display pockets, into which pages may be inserted and read from while inserted; and 3) a secondary display pocket, the secondary display pocket for visually presenting a calendar, and/or a signage or information associated with an organization. The organization may be a corporation, and association, a society, or a person.

In accordance with another aspect of the present invention, the spine may comprise a binder, such as a booklet binder, a comb binder or a spiral binder, to permanently or, in the alternative, semi-permanently and replaceabley, couple a display pocket with the spine.

In one embodiment, the spine further comprises a plurality of articulating binder rings, each articulating binder ring sized and located to extend through one of the at least two holes of a display pocket, and to hold the display pocket in a display position. Each articulating binder ring includes a fixed section and a movable section. The spine further includes a movable bolt device on which all of the movable binder ring sections are commonly mounted, so to move the movable sections in unison with the movable bolt device, whereby the display pocket may be removed from or coupled with the binder assembly as the plurality of binder rings are opened and closed.

Other objects, features, and advantages of the present invention will become apparent from a consideration of the following detailed description and from the accompanying drawings.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a front view of a first preferred embodiment of the present invention in a closed configuration;

FIG. 2 is a front view of the embodiment shown in FIG. 1 in an open position;

FIG. 3 is a rear view illustrating of a spine of a second preferred embodiment of the present invention; and

FIG. 4 is a front view of a third preferred embodiment of the present invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

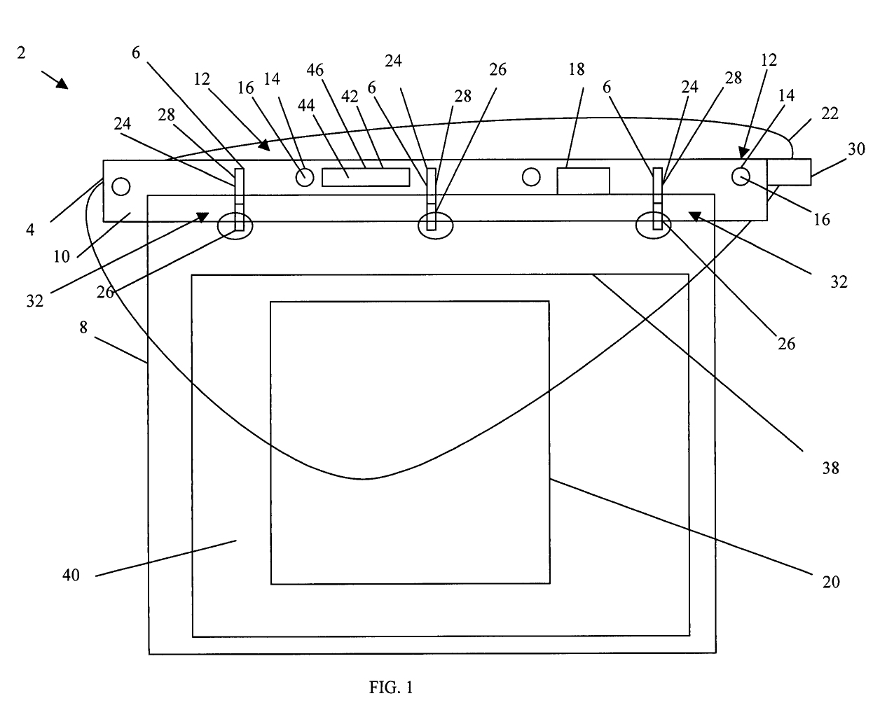

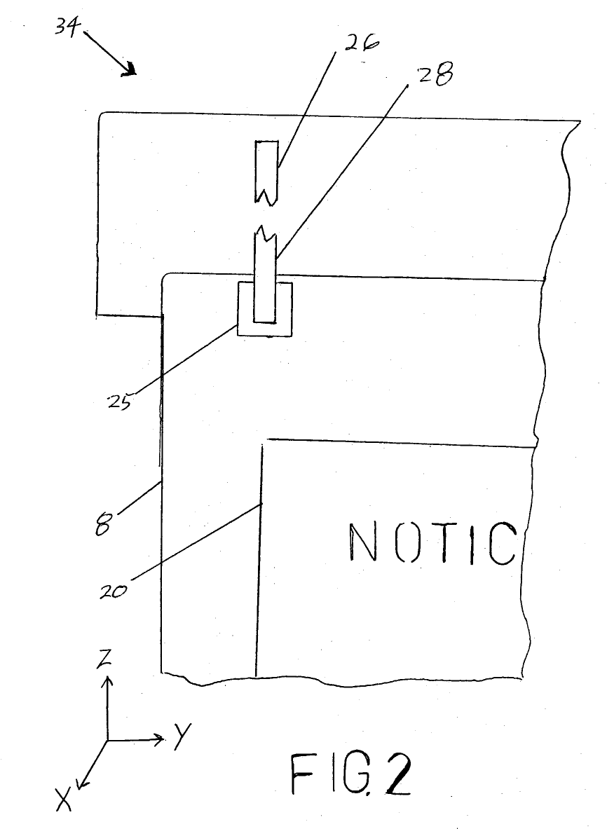

Referring now generally to the Figures and particularly to FIG. 1, FIG. 1 is a front view of a first preferred embodiment of the present invention 2, or first assembly 2, in a closed configuration. The first assembly 2 comprises a spine 4, a ring mechanism 6 and a plurality of display pockets 8. The ring mechanism 6 is attached to a front side 10 of the spine 4 and the plurality of display pockets 8 are removable attached to the ring mechanism 6. The spine 4 has an attachment feature 12 including a plurality of binder apertures 14 and a plurality of elongate fasteners 16. Optional tabs 18 may be attached to display pockets 8 to enable notice to a reader of the informational content of a page 20. The spine 4 is attached to an external object 22, such as a wall by means of the elongate fasteners 16. Each elongate fastener 16 extends through one binder aperture 14 and into the wall 22. The elongate fasteners 16 may be metal screws or nails, or other suitable elongate fasteners known in the art. The ring mechanism 6 may comprise a metal or another suitable material known in the art, and has a plurality of articulating binder rings 24. Each binder ring 24 is sized and located to extend through one of the at least two holes 25 of a display pocket 8 and to allow the display pocket 8 to reside in a flat display position. Each binder ring 24 includes a fixed section 26 and a movable articulating section 28. A movable bolt device 30 of the ring mechanism 6, on which all of the movable articulating binder ring sections 28 are commonly mounted, moves the articulating binder ring sections 28 in unison with a movement of the movable bolt device 30 by a user. The movable bolt device drives the movable sections of the articulating binder rings 24 from a closed position 32 of FIG. 1 to an open position 34 of FIG. 2. When the binder 24 rings are placed into the open positions 34, as shown in FIG. 2, the display pockets 8 may be removed from or coupled with the ring mechanism 6. In the closed position 32 of FIG. 1 the display pockets 8 are securely coupled with the spine 4 and the display pages 20 may be partially rotated about the a ring mechanism 6 by a viewer to better accommodate viewing of a page 20 when inserted into the display pocket by 8 the viewer. The display pocket 8 may be or comprise a transparent plastic material or another suitable material in the art. Each display pocket 8 defines a display space for holding at least one page 20, and the display pocket 8 is optionally open on at least one side 36 for inserting and removing the page 20, whereby the first assembly 2 may protect and present the page 20 for viewing or reading and exhibit with minimal overall weight. Each display pocket 8 may have a slit 38 through which a page 20 may be inserted into or removed from the display pocket 8. The pages 20 may be sheets of one of the sizes of A10 sheets, eight and one half inches by eleven inches, three inches by five inches, or another suitable shape and size known in the art. The display pockets 8 are sized and shaped to be slightly larger, for example one eighth inch in each critical dimension of height, length and width, to accommodate a page 20 of a predetermined shape and size, whereby the page 20 may lie in a substantially flat position within the display pocket 8. A transparent display side 40 of the display pocket 8 allows the viewer to read or examine the page 20 while the page 20 is in the display pocket 8. The spine 4 further comprises a secondary display pocket 42. The secondary display pocket 42 is capable of holding at least one alternate page 44. The secondary display pocket 42 is sized and shaped to accept and enclose the alternate page 44 and is open on at least one side 46 for inserting and removing the alternate page 44. The alternate page 44 may have signage for an organization, such as a logo or trademark a corporation, and a calendar graphic. The secondary display pocket 42 has a transparent window 46 through which the viewer may observe or read the alternate page 44 while the alternate page 44 is located within the secondary display pocket 42.

Referring now generally to the Figures and particularly to FIG. 2, FIG. 2 is a front view of the first assembly 2 shown in FIG. 1 and wherein the articulating rings 24 are in an open position 34. The rings 24 and a plurality of holes 25 of the display pockets 8 are located to allow the rings 24 to extend through the holes 25 and thereby capture the display pockets 8. Closing the rings 24, as per FIG. 1, insures that the display pockets 8 may allow movement of the display pockets 8 within, while simultaneously being constrained, within all three orthogonal geometric dimensions of X for depth, Y for width and Z height.

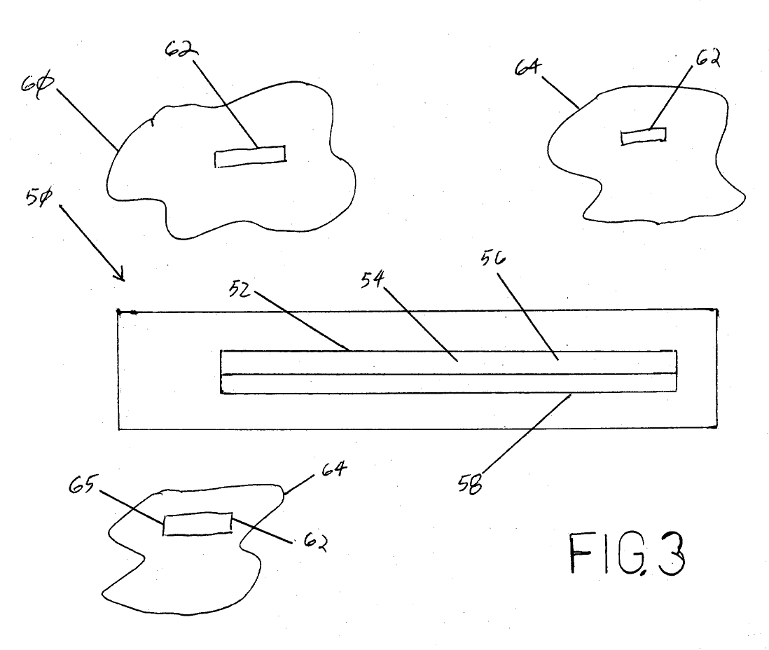

Referring now generally to the Figures and particularly to FIG. 3, FIG. 3 is a rear view illustrating a spine 48 of a second preferred embodiment of the present invention 50, or second assembly 50. An attachment feature 52 includes an attachment strip 54 of the second assembly 50 that may be or comprise an adhesive strip 56 and/or a hook and loop fabric 58. The adhesive strip 56 may be used to attach the second assembly 50 to a relatively flat area of wall, equipment, or another suitable external object 60. In certain alternate preferred embodiments of the present invention, the second assembly 50 additionally or alternately comprises a hook and loop fastener fabric 58. The hook and loop fastener fabric 58 may be used to detachably attach the second assembly 50 to matching hook and loop fabrics 62 located on alternative external objects 60 & 64. In other words, the attachment feature 52 may further or alternatively optionally include a hook and loop fabric pair 65 comprising (1) the first mating portion 62 attached to the external object 60 or 64, and (2) the second mating portion 58 being the hook and loop fastener fabric 58 of the spine 48, whereby the second assembly 50 may be detachably attached to any one of a plurality external of objects 60 & 64, such as a motor vehicle, or a wall, or an instrument.

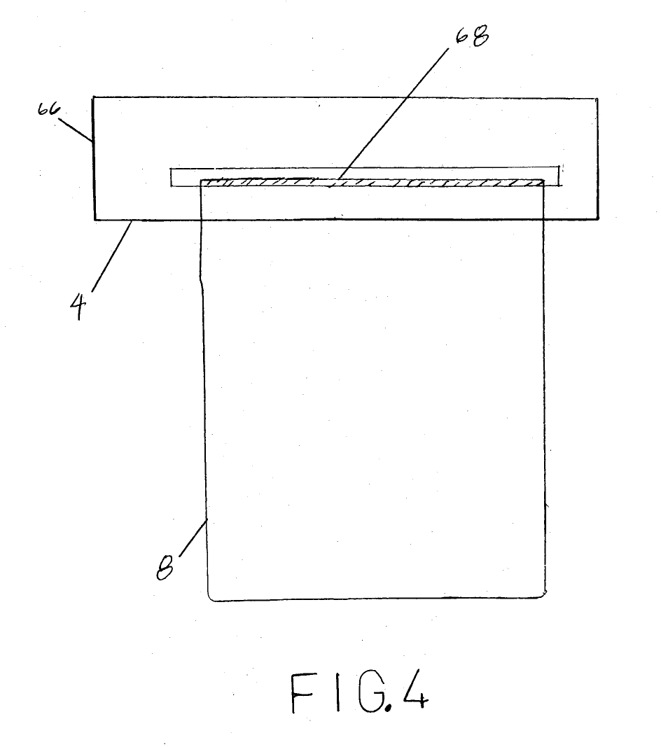

Referring now generally to the Figures and particularly to FIG. 4, FIG. 4 is a front view of a third preferred embodiment 66, or third assembly 66, of the present invention. A spine attachment feature 68 of the third assembly 66 captures and couples the display pages 8 to the spine 4. The spine attachment feature 68 may be or comprise a booklet binder, a spiral binder, or a comb binder in various alternate preferred embodiments of the present invention. Where the display pockets 8 are attached to a booklet binder or a comb binder, the display pockets 8 are pivotably and removably coupled to the spine 4. Where the display pockets are attached to a spiral binder 8, the display pockets are pivotably coupled to the spine 4.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A binder assembly for attachment to an external object, the assembly comprising: a spine, the spine having an attachment feature, the attachment feature for attaching the spine to the external object; and a display pocket pivotally mounted to said spine, the display pocket defining a display space for holding at least one page, and the display pocket open on at least one side for inserting and removing a page, whereby the binder assembly is provided for holding paper in said display pocket, with minimal overall weight.

2. The binder assembly of claim 1, wherein the display pocket is removably coupled with the spine.

3. The binder assembly of claim 1, wherein the binder assembly further comprises a
4. plurality of display pockets.

4. The binder assembly of claim 1, wherein the display pocket has a transparent side, whereby the page is at least partly visible to an outside observer when the page is placed substantially within the display pocket.

5. The binder assembly of claim 1, wherein the spine further comprises a secondary pocket, the secondary pocket having a transparent window, the secondary pocket defining a secondary display space for holding at least one page, and the secondary pocket open on at least one side for inserting and removing a page.

6. The binder assembly of claim 5, wherein the page inserted into the secondary display pocket presents a visual reference to an organization.

7. The binder assembly of claim 5, wherein the page inserted into the secondary display pocket presents a calendar.

8. The binder assembly of claim 1, wherein the attachment feature comprises at least one fastener and at least one binder aperture, the binder aperture extending through the binder and the fastener extending through the binder aperture and partially into the object.

9. The binder assembly of claim 1, wherein the attachment feature comprises at least one screw and at least one binder aperture, the binder aperture extending through the binder and the screw extending through the binder aperture and partially into the object.

10. The binder assembly of claim 1, wherein the attachment feature comprises a hook and loop pair, the hook and loop pair having two mating portions, the first mating portion attached to the object and the second mating object attached to the binder, whereby the binder assembly may be detachably attached to the object.

11. The binder assembly of claim 1, wherein the attachment feature comprises an adhesive strip, whereby the binder assembly may be detachably attached to the object.

12. The binder assembly of claim 1, wherein said display pocket is dimensioned to receive sheet material having a width of about 8½ inches and a length of about 11 inches.

13. The binder assembly of claim 1, wherein said display pocket is dimensioned to receive sheet material having a width of about three inches and a length of about five inches.

14. The binder assembly of claim 1, wherein said display pocket is dimensioned to receive sheet material having a width and a length conforming to A10 size paper.

15. The binder assembly of claim 1, wherein the object is selected from the group consisting of a motorized vehicle, an instrument, a wall and an equipment.

16. The binder assembly of claim 1, wherein the spine attachment feature comprises at least two articulating rings.

17. The binder assembly of claim 1, wherein:
the display pocket further comprises at least two holes; and
the spine further comprises a plurality of binder rings, each binder ring sized and located to extend through one of the at least two holes and hold the display pocket in a display position, each binder ring including a fixed section and a movable section, and a movable bolt device on which all of said movable binder ring sections are commonly mounted so to move in unison with the movable bolt device, whereby the display pocket may be removed from or coupled with the binder assembly as the plurality of binder rings are opened and closed.

18. The binder assembly of claim 1, wherein the spine further comprises a spiral binder, and the display pocket is pivotably attached to the spiral binder.

19. The binder assembly of claim 1, wherein the binder assembly further comprises a plurality of display pockets and at least one of the plurality of pockets has a tab.

20. The binder assembly of claim 1, wherein the spine further comprises a comb binder, and the display pocket is pivotably and removably attached to the comb binder.
